(19) United States
(12) Patent Application Publication
(10) Pub. No.: US 2019/0013161 A1
(43) Pub. Date: Jan. 10, 2019

(54) KEYBOARD

(71) Applicant: Primax Electronics Ltd., Taipei (TW)

(72) Inventor: Sheng-Fan Chang, Taipei (TW)

(21) Appl. No.: 15/811,632

(22) Filed: Nov. 13, 2017

(30) Foreign Application Priority Data
Jul. 7, 2017 (TW) 106122891

(51) Int. Cl. H01H 13/70

(52) U.S. Cl. CPC H01H 13/70; H01H 2215/004; H01H 2203/002

(57) ABSTRACT

The present invention relates to a keyboard, including a base plate, a switch circuit board, a connecting element, a keycap, and a connecting shaft. The switch circuit board is disposed on the base plate, the connecting element is located on the switch circuit board and is separately connected to the keycap and the base plate, the connecting shaft is disposed on the connecting element and extends from the connecting element to be connected to the base plate. When the keycap is pressed and the connecting element swings, the connecting shaft rotates and is separately in contact with the base plate and the switch circuit board, so as to weaken the shake of the connecting element. Therefore, the operation stability of the keyboard can be improved.

### FIELD OF THE INVENTION

The present invention relates to an input apparatus, and in particular, to a keyboard including a plurality of key structures.

### BACKGROUND OF THE INVENTION

A common peripheral input apparatus of a computer includes a mouse, a keyboard, a track ball, and the like. The keyboard can be directly used for inputting a word and a symbol into the computer, and therefore gets great attention from users and input apparatus manufacturers. A relatively common keyboard is a keyboard including a plurality of key structures.

An architecture of the key structure in the keyboard is described below, and a key structure including a scissor-type connecting element is used as an example for description. Referring to FIG. 1, FIG. 1 is a schematic side cross-sectional view of a conventional key structure. The conventional key structure 1 includes a keycap 11, a scissor-type connecting element 12, an elastic rubber body 13, a thin film switch circuit 14, and a base plate 15, and the base plate 15 is used for carrying the keycap 11, the scissor-type connecting element 12, the elastic rubber body 13, and the thin film switch circuit 14. The scissor-type connecting element 12 is used for connecting the base plate 15 and the keycap 11.

The scissor-type connecting element 12 is located between the base plate 15 and the keycap 11 and is separately connected to the base plate 15 and the keycap 11. The scissor-type connecting element 12 includes a first frame 121 and a second frame 122. A first end of the first frame 121 is connected to the keycap 11, and a second end of the first frame 121 is connected to the base plate 15. The elastic rubber body 13 is encircled by the scissor-type connecting element 12, and the thin film switch circuit 14 has a plurality of key connection points (not shown). A corresponding key signal is output when each key connection point is triggered. The elastic rubber body 13 is disposed on the thin film switch circuit 14, and one elastic rubber body 13 corresponds to one key connection point. When being pressed, the elastic rubber body 13 is deformed and presses the corresponding key connection point in the thin film switch circuit 14 to generate a key signal.

An operation case in which the conventional key structure 1 is pressed by a user is described below. In FIG. 1, when the user presses the keycap 11, the keycap 11 is applied with a force to push the scissor-type connecting element 12 to move. Therefore, the keycap 11 can move downwards relative to the base plate 15 and presses the corresponding elastic rubber body 13. In this case, the elastic rubber body 13 is deformed and presses the thin film switch circuit 14 to trigger the key connection point of the thin film switch circuit 14, so that the thin film switch circuit 14 outputs a corresponding key signal. When the user stops pressing the keycap 11, the keycap 11 is not applied with the force any more and stops pressing the elastic rubber body 13, so that the elastic rubber body 13 restores its original shape due to elasticity and provides an upward elastic restoring force. In this way, the keycap 11 is pushed back to a location before the pressing. The foregoing is the architecture and the operation case of the conventional key structure.

However, in the process in which the keycap 11 is pressed, the scissor-type connecting element 12 inevitably shakes, resulting in the shake of the entire key structure 1. Consequently, the operation stability of the keyboard is affected. Therefore, a keyboard whose operation stability can be improved is required.

### SUMMARY OF THE INVENTION

An objective of the present invention is to provide a keyboard whose operation stability can be improved.

In a preferred embodiment, the present invention provides a keyboard, including a base plate, a switch circuit board, a connecting element, a keycap, and a connecting shaft. The base plate has a base plate hook, and the switch circuit board is disposed on the base plate. The connecting element is located on the switch circuit board and is connected to the base plate, and the keycap is exposed outside the keyboard and is connected to the connecting element. The connecting shaft is disposed on the connecting element, extends from the connecting element to be connected to the base plate hook, and is separately in contact with the base plate and the switch circuit board. When the keycap is pressed and the connecting element swings, the connecting shaft rotates and is separately in contact with the base plate and the switch circuit board, so as to weaken the shake of the connecting element.

In a preferred embodiment, the present invention provides a keyboard, including a base plate, a switch circuit board, a thin film, a connecting element, a keycap, and a connecting shaft. The base plate has a base plate hook, the switch circuit board is disposed on the base plate, and the thin film is disposed on the switch circuit board. The connecting element is located on the switch circuit board and is connected to the base plate, and the keycap is exposed outside the keyboard and is connected to the connecting element. The connecting shaft is disposed on the connecting element, extends from the connecting element to be connected to the base plate hook, and is separately in contact with the base plate and the thin film. When the keycap is pressed and the connecting element swings, the connecting shaft rotates and is separately in contact with the base plate and the thin film, so as to weaken the shake of the connecting element.

In a preferred embodiment, the connecting shaft includes a main shaft body and an extension shaft, the main shaft body extends from a side wall of the first frame, and a lower surface of the main shaft body is in contact with the base plate. The extension shaft is disposed on the main shaft body and extends from the main shaft body, and a lower surface of the extension shaft can be in contact with the switch circuit board.

In a preferred embodiment, the extension shaft includes a contact protrusion portion and at least one contact plane, the contact protrusion portion is disposed on the lower surface of the extension shaft and is in contact with the switch circuit board. The shape of the contact protrusion portion helps the connecting shaft rotate. The at least one contact plane is disposed on the lower surface of the extension shaft and is located on a side of the contact protrusion portion. The at least one contact plane can be in contact with the switch circuit board, so as to form a support point of the connecting element.

In short, in the keyboard in the present invention, the connecting shaft is disposed on the connecting element, so that the connecting shaft can be in contact with the base plate and the switch circuit board (or the thin film) both. The partial shape of the connecting shaft can help the connecting element swing. In addition, the connecting shaft can be in contact with the switch circuit board (or the thin film) to form the support point of the connecting element, so that the connecting element can stably swing, to improve the operation stability of the keyboard.

### BRIEF DESCRIPTION OF THE DRAWINGS

FIG. 1 is a schematic side cross-sectional view of a conventional key structure;

FIG. 2 is a partial schematic structural exploded view of a keyboard according to a first preferred embodiment of the present invention;

FIG. 3 is a partial schematic structural view of a connecting shaft of a keyboard according to a first preferred embodiment of the present invention;

FIG. 4 is a partial schematic structural view of a keyboard according to a first preferred embodiment of the present invention; and

FIG. 5 is a partial schematic structural view of a keyboard according to a second preferred embodiment of the present invention.

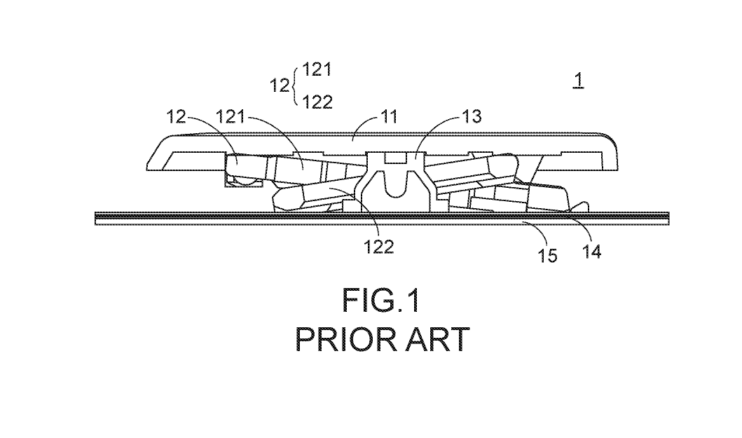

### DETAILED DESCRIPTION OF THE PREFERRED EMBODIMENT

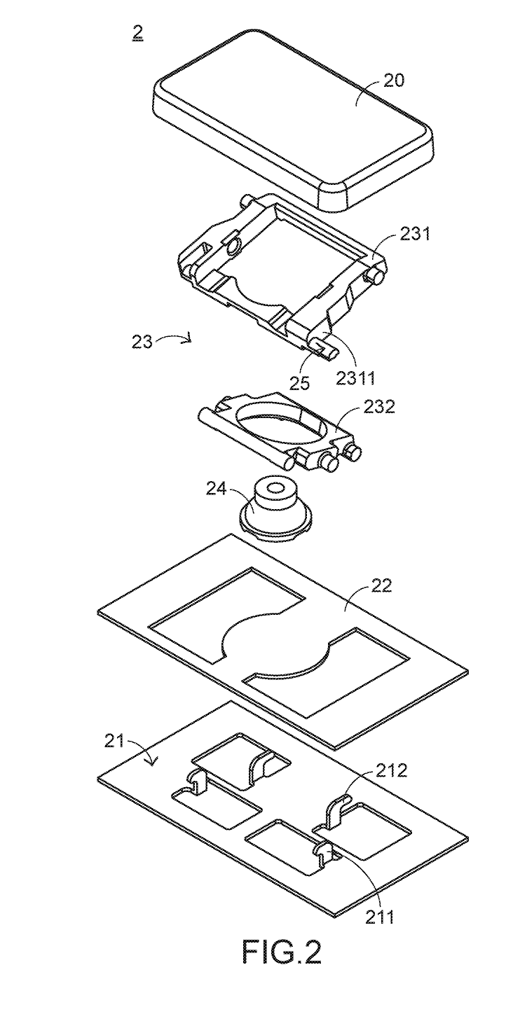

In view of the problem in the conventional technology, the present invention provides a keyboard that can resolve the problem in the conventional technology. First, the structure of the keyboard in the present invention is described. Referring to FIG. 2, FIG. 2 is a partial schematic structural exploded view of the keyboard according to a first preferred embodiment of the present invention. The keyboard 2 in the present invention includes a plurality of keycaps 20 (only one being shown), a base plate 21, a switch circuit board 22, a plurality of connecting elements 23 (only one being shown), a plurality of elastic elements 24 (only one being shown), and a plurality of connecting shafts 25 (only one being shown). The base plate 21 is disposed below the plurality of keycaps 20, and the base plate 21 includes a plurality of first base plate hooks 211 and a plurality of second base plate hooks 212. The switch circuit board 22 is disposed on the base plate 21 and is located between the plurality of keycaps 20 and the base plate 21, and each elastic element 24 is located between the corresponding keycap 20 and the switch circuit board 22. When the keycap 20 is pressed by a user to move, the elastic element 24 is pushed by the keycap 20 to abut against the switch circuit board 22, so that the switch circuit board 22 outputs a corresponding key signal. In this preferred embodiment, the switch circuit board 22 is a thin film switch circuit, and the elastic element 24 is an elastic rubber body. The inner structure of the switch circuit board 22 is formed by an upper line board, a lower line board, and an isolating layer, this is known by a person skilled in the art, and details are not described herein.

The plurality of keycaps 20 is exposed outside the keyboard 2 and is respectively connected to the corresponding connecting elements 23, and the base plate 21 is also connected to the plurality of connecting elements 23. That is, the keycaps 20 are disposed on the base plate 21 by using the connecting elements 23. The plurality of connecting elements 23 is located on the base plate 21 and is respectively connected to the base plate 21 and the corresponding keycaps 20. Each connecting element 23 includes a first frame 231 and a second frame 232, a first end of the first frame 231 is connected to the first base plate hook 211, and a second end of the first frame 231 is connected to the keycap 20. The second frame 232 is combined with the first frame 231 and can swing relative to the first frame 231, a first end of the second frame 232 is connected to the keycap 20, and a second end of the second frame 232 is connected to the second base plate hook 212. The second frame 232 can swing relative to the first frame 231. Therefore, when the keycap 20 is pressed, the keycap 20 can move up and down relative to the base plate 21 with the swing of the connecting element 23. In this preferred embodiment, the connecting element 23 is a scissor-type connecting element.

On the other hand, one connecting shaft 25 corresponds to one connecting element 23, is disposed on the corresponding connecting element 23, and extends from the connecting element 23, so as to be connected to the corresponding first base plate hook 211. In addition, the connecting shaft 25 can be separately in contact with the base plate 21 and the switch circuit board 22 when the keyboard 2 is in a combined state. When the keycap 20 is pressed by a user and the corresponding connecting element 23 swings, the connecting shaft 251 rotates and is separately in contact with the base plate 21 and the switch circuit board 22, so as to weaken the shake of the connecting element 23.

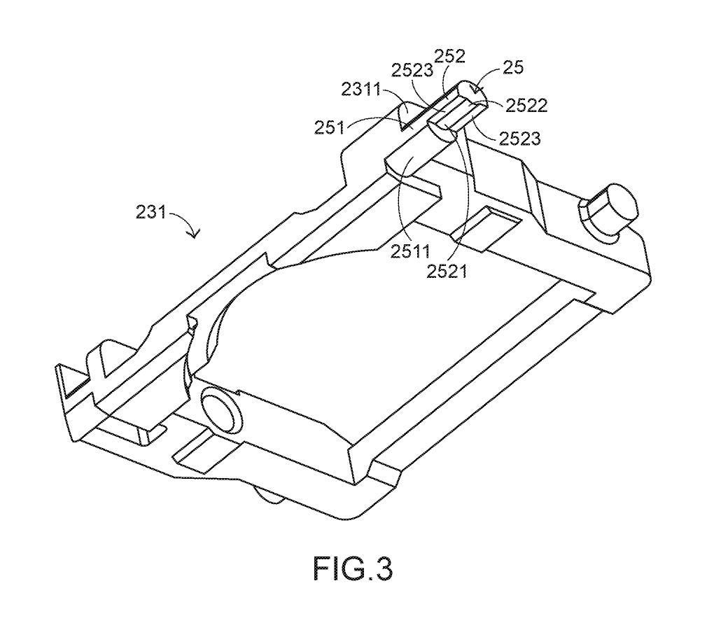

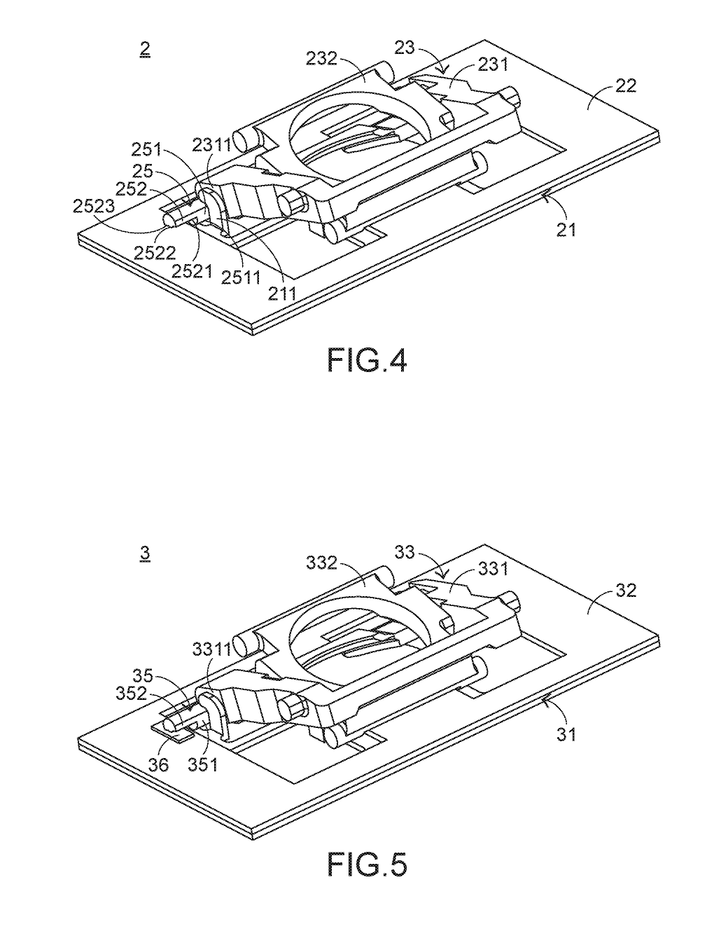

Referring to FIG. 2 and FIG. 3 together, FIG. 3 is a partial schematic structural view of the connecting shaft of the keyboard according to the first preferred embodiment of the present invention. FIG. 3 shows the structure of the connecting shaft 25, and the connecting shaft 25 is disposed on the first frame 231 of the corresponding connecting element 23. The connecting shaft 25 is disposed on the first end of the first frame 231 and extends from a side wall 2311 of the first frame 231. The connecting shaft 25 includes a main shaft body 251 and an extension shaft 252. The main shaft body 251 extends from the side wall 2311 of the first frame 231 and is connected to the first base plate hook 211, and a lower surface 2511 of the main shaft body 251 can be in contact with the base plate 21 when the keyboard 2 is in the combined state, as shown in FIG. 4. The extension shaft 252 is disposed on the main shaft body 251 and extends from the main shaft body 251, and a lower surface 2521 of the extension shaft 252 can be in contact with the switch circuit board 22 when the keyboard 2 is in the combined state, as shown in FIG. 4. In this preferred embodiment, the main shaft body 251 and the extension shaft 252 are integrated with the first frame 231.

In FIG. 3, the extension shaft 252 includes a contact protrusion portion 2522 and two contact planes 2523. The contact protrusion portion 2522 is disposed on the lower surface 2521 of the extension shaft 252 and is in contact with the switch circuit board 22. The two contact planes 2523 are disposed on the lower surface 2521 of the extension shaft 252 and are located on two sides of the contact protrusion portion 2522. The two contact planes 2523 can be in contact with the switch circuit board 22 when the connecting shaft 25 rotates, to form a support point of the connecting element 23, so as to stabilize the connecting element 23. In addition, the extension shaft 252 can help the connecting shaft 25 rotate with the shape of the contact protrusion portion 2522, so that the connecting shaft 25 can rotate smoothly. In this preferred embodiment, the contact protrusion portion 2522 and the two contact planes 2523 are integrated with the extension shaft 252, and the contact protrusion portion 2522 has a shape of a curved strip.

An operation case in which the keycap 20 is pressed is described below. When a user presses any keycap 20, the keycap 20 moves downwards relative to the base plate 21, so that the connecting element 23 is pushed to swing, and the keycap 20 moving downwards pushes the elastic element 24, so that the elastic element 24 is abutted against to be deformed and to trigger the switch circuit board 22 to generate a corresponding key signal. In the swing process of the connecting element 23, the curved strip shape of the contact protrusion portion 2522 can help the connecting shaft 25 to rotate smoothly, and the contact planes 2523 can be in contact with the switch circuit board 22, to form the support point of the connecting element 23, so that the connecting element 23 can stably swing, to improve the operation stability of the keycap 20. When the user does not press the keycap 20 any more, the keycap 20 may move upwards relative to the base plate 21 due to an elastic force generated when the elastic element 24 recovers from a deformation state, the connecting element 23 is driven to swing to recover from a superposed state to an open state, and the keycap 20 recovers to a location before the pressing.

It should be particularly noted that although only the structure in which the connecting shaft is disposed on the first frame is disclosed in this preferred embodiment, the structure in which the connecting shaft is disposed on a side wall of the second frame of the keyboard does not depart from the spirit disclosed in the present invention and belongs to the application patent scope of the keyboard in the present invention.

In addition, the present invention further provides a second preferred embodiment providing a different manufacturing method from the foregoing embodiment. Referring to FIG. 5, FIG. 5 is a partial schematic structural view of a keyboard according to the second preferred embodiment of the present invention. The keyboard 3 in the present invention includes a plurality of keycaps (not shown), a base plate 31, a switch circuit board 32, a plurality of connecting elements 33 (only one being shown), a plurality of elastic elements (not shown), a plurality of connecting shafts 35 (only one being shown), and a thin film 36. Each connecting element 33 includes a first frame 331 and a second frame 332, and the connecting shaft 35 is disposed on a side wall 3311 of the corresponding first frame 331 and includes a main shaft body 351 and an extension shaft 352. In this preferred embodiment, the structure of keyboard 3 is almost the same as the structure of the keyboard 2 in the foregoing preferred embodiment, and the similarity is not described herein again. A difference between the two is that the thin film 36 is disposed in the keyboard 3.

In FIG. 5, the thin film 36 corresponds to the connecting shaft 35, is disposed on the switch circuit board 32, and is located between the connecting shaft 35 and the switch circuit board 32. That is, the main shaft body 351 of the connecting shaft 35 can be in contact with the base plate 31, and the extension shaft 352 is in contact with the thin film 36. The thin film 36 can provide a protection function, so as to avoid abrasion when the switch circuit board 32 is in contact with the connecting shaft 35 for a long time. In this preferred embodiment, the thin film 36 is a plastic thin film whose size is slightly larger than that of the connecting shaft 35. This is merely an example rather than a limitation. In another preferred embodiment, the thin film may be a plastic thin film having a same size as the switch circuit board or of any size. In addition, an operation case of the keyboard 3 in this preferred embodiment is similar to the operation case of the keyboard 2 in the foregoing preferred embodiment, and details are not described herein again.

It can be learned from the foregoing that in the keyboard in the present invention, the connecting shaft is disposed on the connecting element, so that the connecting shaft can be in contact with the base plate and the switch circuit board (or the thin film) both. The partial shape of the connecting shaft can help the connecting element swing. In addition, the connecting shaft can be in contact with the switch circuit board (or the thin film) to form the support point of the connecting element, so that the connecting element can stably swing, to improve the operation stability of the keyboard.

The foregoing descriptions are merely preferred embodiments of the present invention but are not intended to limit the application patent scope of the present invention. Therefore, any equivalent change or modification made without departing from the spirit disclosed in the present invention shall fall within the application patent scope of the present invention.

What is claimed is:

1. A keyboard, comprising:
a base plate, having a base plate hook;
a switch circuit board, disposed on the base plate;
a connecting element, located on the switch circuit board and connected to the base plate;
a keycap, exposed outside the keyboard and connected to the connecting element; and
a connecting shaft, disposed on the connecting element, extending from the connecting element to be connected to the base plate hook, and separately in contact with the base plate and the switch circuit board, wherein when the keycap is pressed and the connecting element swings, the connecting shaft rotates and is separately in contact with the base plate and the switch circuit board, so as to weaken the shake of the connecting element.

2. The keyboard according to claim 1, wherein the connecting element further comprises:
a first frame, a first end of the first frame being connected to the base plate hook, a second end of the first frame being connected to the keycap, wherein the connecting shaft is disposed on the first end of the first frame and extends from a side wall of the first frame; and
a second frame, combined with the first frame and capable of swinging relative to the first frame, a first end of the second frame being connected to the keycap, and a second end of the second frame being connected to the base plate.

3. The keyboard according to claim 2, wherein the connecting shaft comprises:
a main shaft body, extending from the side wall of the first frame, wherein a lower surface of the main shaft body is in contact with the base plate; and
an extension shaft, disposed on the main shaft body and extending from the main shaft body, wherein a lower surface of the extension shaft can be in contact with the switch circuit board.

4. The keyboard according to claim 3, wherein the extension shaft comprises:
a contact protrusion portion, disposed on the lower surface of the extension shaft and in contact with the switch circuit board, wherein the shape of the contact protrusion portion helps the connecting shaft rotate; and
at least one contact plane, disposed on the lower surface of the extension shaft and located on a side of the contact protrusion portion, wherein the at least one contact plane can be in contact with the switch circuit board, so as to form a support point of the connecting element.

5. The keyboard according to claim 4, wherein the contact protrusion portion has a shape of a curved strip.

6. The keyboard according to claim 1, further comprising an elastic element located between the keycap and the switch circuit board and configured to abut against the switch circuit board when being pushed by the moving keycap, so that the switch circuit board outputs a key signal, wherein when the elastic element is not pushed by the keycap any more, the elastic element provides an elastic force for the keycap.

7. A keyboard, comprising:
a base plate, having a base plate hook;
a switch circuit board, disposed on the base plate;
a thin film, disposed on the switch circuit board;
a connecting element, located on the switch circuit board and connected to the base plate;
a keycap, exposed outside the keyboard and connected to the connecting element; and
a connecting shaft, disposed on the connecting element, extending from the connecting element to be connected to the base plate hook, and separately in contact with the base plate and the thin film, wherein when the keycap is pressed and the connecting element swings, the connecting shaft rotates and is separately in contact with the base plate and the thin film, so as to weaken the shake of the connecting element.

8. The keyboard according to claim 7, wherein the connecting element comprises:
a first frame, a first end of the first frame being connected to the base plate hook, a second end of the first frame being connected to the keycap, wherein the connecting shaft is disposed on the first end of the first frame and extends from a side wall of the first frame; and
a second frame, combined with the first frame and capable of swinging relative to the first frame, a first end of the second frame being connected to the keycap, and a second end of the second frame being connected to the base plate.

9. The keyboard according to claim 8, wherein the connecting shaft comprises:
a main shaft body, extending from the side wall of the first frame, wherein a lower surface of the main shaft body is in contact with the base plate; and
an extension shaft, disposed on the main shaft body and extending from the main shaft body, wherein a lower surface of the extension shaft can be in contact with the thin film.

10. The keyboard according to claim 9, wherein the extension shaft comprises:
a contact protrusion portion, disposed on the lower surface of the extension shaft and in contact with the thin film, wherein the shape of the contact protrusion portion helps the connecting shaft rotate; and
at least one contact plane, disposed on the lower surface of the extension shaft and located on a side of the contact protrusion portion, wherein the at least one contact plane can be in contact with the thin film, so as to form a support point of the connecting element.
